(19) United States
(12) Patent Application Publication
(10) Pub. No.: US 2026/0131585 A1
(43) Pub. Date: May 14, 2026

(54) Media Cartridge with Core Locking Mechanism

(71) Applicant: Zebra Technologies Corporation, Lincolnshire, IL (US)

(72) Inventors: Timothy T. Anderson, Antioch, IL (US); Steve Ting Kei Chow, Monterey Park, CA (US); Morgan Hassan Malone, Swansea, MA (US)

(73) Assignee: Zebra Technologies Corporation, Lincolnshire, IL (US)

(21) Appl. No.: 18/942,044

(22) Filed: Nov. 8, 2024

(51) Int. Cl. B41J 15/04; B41J 15/02; B65H 16/00

(52) U.S. Cl. CPC B41J 15/044; B41J 15/02; B65H 16/005; B65H 2801/15

(57) ABSTRACT

An example disclosed herein includes a media cartridge. The media cartridge includes a housing, including a spindle configured to rotatively support a media roll, the spindle having a hollow cylindrical profile and a slot, a media roll including a roll core, the roll core configured to rotate about the spindle, the roll core including a plurality of internal teeth disposed about an internal circumference of the roll core and a web of media, wound about the roll core, and a roll stop assembly configured to transition between a roll hold position and a roll release position, including an arm, rotatively coupled to the housing, wherein a portion of the arm is configured to extend through the slot of the spindle and into the hollow cylindrical profile, the portion of the arm including an embossment including at least an external tooth, a biasing member, configured to bias the arm into the roll hold position.

### BACKGROUND

Media processing devices, namely printers or other systems, can process media from a media cartridge. The media contained within the media cartridge can include wristbands, labels, receipt media, cards, and the like. When the media contained in the media cartridge is configured as a roll, or as a spool, controlling the rotation and output of the roll or spool may prevent the leading edge of the media from retracting into the media cartridge or unintentional dispense during shipping and handling of the media cartridge before it is installed in a media processing device and/or may reduce instances of media blockages and jams as the media is processed.

### BRIEF DESCRIPTION OF THE DRAWINGS

FIG. 1 illustrates a media processing device containing a media cartridge, according to embodiments of the present disclosure.

FIG. 2 illustrates a perspective view of an example media cartridge, according to embodiments of the present disclosure.

FIGS. 3A-3B illustrate profile views of the media cartridge of FIG. 2, according to embodiments of the present disclosure.

FIG. 4A illustrates a profile view of a second portion of a housing of the media cartridge of FIG. 2, including a roll stop assembly, according to embodiments of the present disclosure.

FIG. 4B illustrates a detailed view of the second portion of the housing of the media cartridge of FIG. 2, according to embodiments of the present disclosure.

FIG. 5 illustrates a detailed view of an arm of the roll stop assembly of FIG. 4, according to embodiments of the present disclosure.

FIG. 6A illustrates a media roll according to embodiments of the present disclosure.

FIG. 6B illustrates a roll core of the media roll of FIG. 6A, according to embodiments of the present disclosure.

FIGS. 7A-7C illustrate views of the second portion of the housing of the media cartridge and the roll stop assembly in a roll hold position, according to embodiments of the present disclosure.

FIGS. 8A-8C illustrate views of the second portion of the housing of the media cartridge and the roll stop assembly in the roll release position, according to embodiments of the present disclosure.

FIG. 9 illustrates a media stop assembly of the media cartridge, according to embodiments of the present disclosure.

### SUMMARY

In an embodiment, the technology of the present disclosure is provided by a media cartridge including a housing, including a spindle configured to rotatively support a media roll, the spindle having a hollow cylindrical profile and a slot, a media roll including a roll core, the roll core configured to rotate about the spindle, the roll core including a plurality of internal teeth disposed about an internal circumference of the roll core and a web of media, wound about the roll core, and a roll stop assembly configured to transition between a roll hold position and a roll release position, including an arm, rotatively coupled to the housing, wherein a portion of the arm is configured to extend through the slot of the spindle and into the hollow cylindrical profile, the portion of the arm including an embossment including at least an external tooth, a biasing member, configured to bias the arm into the roll hold position, wherein, when in the roll hold position, the external tooth of the embossment of the arm engages with at least one of the plurality of internal teeth of the roll core, blocking the media roll from rotating about the spindle, and wherein the roll stop assembly is configured to transition from the roll hold position to the roll release position by rotating the arm such that the external tooth disengages from the at least one of the plurality of internal teeth, wherein, when in the roll release position, the external tooth is retracted away from the plurality of internal teeth, such that the media roll is rotatable about the spindle.

In another aspect of the technology of the present disclosure, a mating angle between the at least one of the plurality of internal teeth and the external tooth is configured such that when a rotative force is applied to the media roll when the roll stop assembly is in the roll hold position, the external tooth is biased towards the roll core.

In another aspect of the technology of the present disclosure, each internal tooth of the plurality of internal teeth includes a first tooth face opposed to a second tooth face, the first tooth face defined in a first plane and the second tooth face defined in a second plane, such that the first plane and the second plane intersect at a point that is located at a greater distance from a radial center of the roll core than an internal circumference of the roll core.

In another aspect of the technology of the present disclosure, the plurality of internal teeth are configured such that a gap width of a gap between each pair of teeth of the plurality of internal teeth is at least 1.5 times a tooth width of the external tooth.

In another aspect of the technology of the present disclosure, the embossment includes a plurality of external teeth, each external tooth of the plurality of external teeth configured to simultaneously engage with the plurality of internal teeth of the roll core when the roll stop assembly is in the roll hold position.

In another aspect of the technology of the present disclosure, the biasing member is a leaf spring.

In another aspect of the technology of the present disclosure, the biasing member is integrally formed with the arm.

In another aspect of the technology of the present disclosure, the roll stop assembly includes a tab which extends through an opening in the housing and is coupled to the arm, configured to receive an external force which transitions the roll stop assembly from the roll hold position to the roll release position.

In another aspect of the technology of the present disclosure, the tab is a first tab configured to receive the external force from a printer.

In another aspect of the technology of the present disclosure, the media cartridge further includes a protrusion on the arm configured to receive an external force from a user applying a force, such that the roll stop assembly is transitioned from the roll hold position to the roll release position.

In another aspect of the technology of the present disclosure, the media cartridge further includes a media stop assembly configured to translate between a media release position and a media hold position, such that when the media stop assembly is in the media hold position, media web of media is pinched between the media stop assembly and a surface and when the media stop assembly is in the media release position, the media stop assembly is separated from the surface and permits movement of the web of media.

In another aspect of the technology of the present disclosure, the roll stop assembly is configured to be transitioned from the roll hold position to the roll release position and the media stop assembly is configured to be transitioned from the media hold position to the media release position responsive to a single action.

In another aspect of the technology of the present disclosure, the housing comprises structural ribs, the structural ribs comprising reliefs disposed proximately to the spindle.

In another aspect of the technology of the present disclosure, the housing is formed by a first housing side and a second housing side, and the spindle is formed by a first spindle portion, integrally formed with the first housing side and a second spindle portion integrally formed with the second housing side, the slot formed in one of the first spindle portion or the second spindle portion.

In another aspect of the technology of the present disclosure, the embossment includes a curved surface matched with an internal surface of the hollow cylindrical profile of the spindle.

In an embodiment, the technology of the present disclosure may also be provided by a media cartridge including a housing, including a spindle configured to rotatively support a media roll, the spindle having a hollow cylindrical profile and a slot, and a roll stop assembly configured to transition between a roll hold position and a roll release position, including: an arm, rotatively coupled to the housing, wherein a portion of the arm is configured to extend through the slot of the spindle and into the hollow cylindrical profile, the portion of the arm including an embossment including at least an external tooth, a biasing member, configured to bias the arm into the roll hold position, wherein, when in the roll hold position, the external tooth of the embossment of the arm protrudes from the spindle through the slot, and wherein the roll stop assembly is transitioned from the roll hold position to the roll release position by rotating the arm such that the external tooth is translated towards a radial center of the hollow cylindrical profile and out of the slot, wherein, when in the roll release position, the external tooth retracts into the spindle away from the slot.

In another aspect of the technology of the present disclosure, the media cartridge further includes a media roll including a roll core, the roll core configured to rotate about the spindle, including a plurality of internal teeth disposed about an internal circumference of the roll core; and a web of media, wound about the roll core; wherein when in the roll hold position, the external tooth of the embossment of the arm engages with the plurality of internal teeth of the roll core, blocking the media roll from rotating about the spindle wherein, when in the roll release position, the external tooth is disengaged from the plurality of internal teeth and permits rotation of the media roll.

In another aspect of the technology of the present disclosure, the media cartridge further includes a media roll, including a roll core, including a plurality of internal teeth disposed about an internal circumference of the roll core, wherein each internal tooth of the plurality of internal teeth includes a first tooth face opposed to a second tooth face, the first tooth face defined in a first plane and the second tooth face defined in a second plane, such that the first plane and the second plane intersect at a point that is located at a distance from a radial center of the roll core greater than a radius of the internal circumference of the roll core, and a web of media, wound about the roll core.

In another aspect of the technology of the present disclosure, the web of media is comprised of media elements selected from a group consisting of labels, wristbands, RFID tags, printable media, and combinations thereof.

### DETAILED DESCRIPTION

Embodiments of the present disclosure now will be described more fully hereinafter with reference to the accompanying drawings, in which some, but not all embodiments of the disclosure are shown. Indeed, the embodiments of the present disclosure can have many different forms and should not be construed as limited to the embodiments set forth herein; rather, these embodiments are provided so that this disclosure will satisfy applicable legal requirements. Like numbers refer to like elements throughout.

Media processing devices require media to process in order to operate. The media may be provided by a variety of sources. One such media source may be provided to the media processing device as a media roll supported within a media cartridge (or cartridge). In some embodiments, a media cartridge is loaded into the media processing device such that the media contained within the media cartridge can be drawn out by the media processing device during operation. The use of media cartridges is advantageous as the cartridge is easily loaded into and removed within a media processing device by a user who does not have to be an expert in the field of media processing. Many different types of media may come in cartridges, including media labels of different lengths and widths or wristbands. Cartridges may be designed such that when the cartridge is installed it automatically feeds media from the cartridge to the media processing device for processing.

When the media is installed in the media cartridges (e.g., during manufacturing), a leading terminal end of the media is threaded through media guides to an outlet of the media cartridges. During shipping and handling of the media cartridges it is possible for the media to retract into the media cartridge and/or for the media roll to unwind. To prevent the leading edge of the media from inadvertently retracting into the media cartridge and/or to prevent the media roll from inadvertently unwinding, the media cartridge can include one or more locking structures that hold the leading edge of the media in place at the media outlet and prevent the media roll from unwinding until the media cartridge is installed in a media processing device at which time the media processing device can control the media.

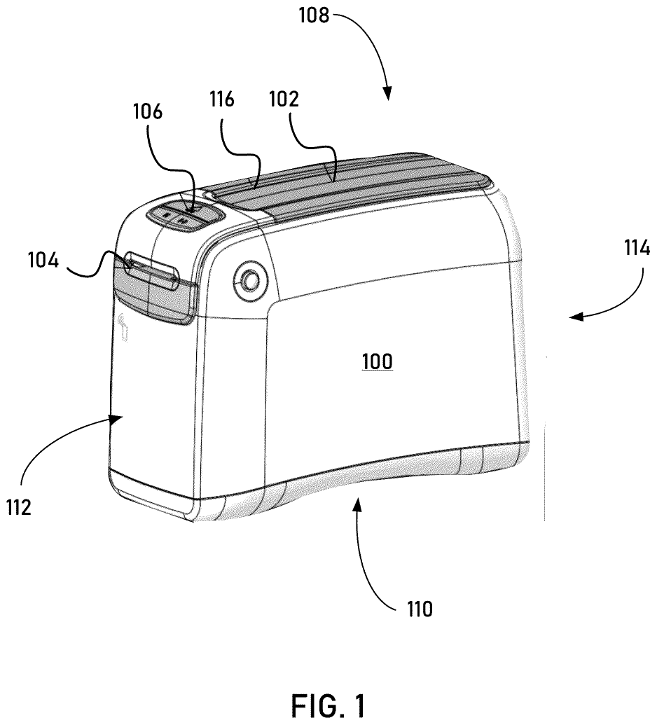

FIG. 1 depicts a media processing device 100 (otherwise referred to herein as “printer”). While the illustrated embodiments and description provided herein are directed primarily to a printing device, other media processing devices such as media encoders, label applicators, or laminators, may benefit from the mechanisms described. The depicted embodiment is of a direct thermal printer, however one skilled in the art would appreciate that other types of thermal printers, such as thermal transfer printers, may be used.

The media processing device 100 is configured to receive a cartridge 102 within a slot 116. The slot 116 may be located on a top side 108 of the media processing device 100, where the cartridge 102 may be entered, and pushed down into place by a user. The media processing device 100 configuration as depicted in FIG. 1 is occasionally referred to as a “toaster” type printer. In some embodiments, the cartridge 102 may contains a roll of labels to process, and in other embodiments the cartridge 102 may include wristbands, RFID tags, thermally printable media, or any other type of media that can be printed and coded or in which indicia can be applied. The media processing device 100 further includes an output 104, the output 104 being disposed on a front side of the media processing device 100. The front side 112 of the printer is opposite a rear side 114 of the media processing device 100 and the media processing device 100 further includes a bottom side 110 of the media processing device 100. The top side 108 and the bottom side 110 of the media processing device 100 are relative to a possible surface that the media processing device 100 might rest on during operation.

As depicted in FIG. 1, the output 104 of the media processing device 100 is configured to allow media to exit the media processing device 100 after processing. As will be discussed further below, the output 104 is configured to align with a media output of the cartridge 102 such that media exiting the cartridge 102 for processing can be processed and immediately expelled from the media processing device 100. The media processing device 100 may also feature inputs 106, depicted in FIG. 1 as buttons. The inputs 106 allow the user to control elements of the print operation to dispel additional media, pause processing, skip a current processing operation, or other processing operations known in the art.

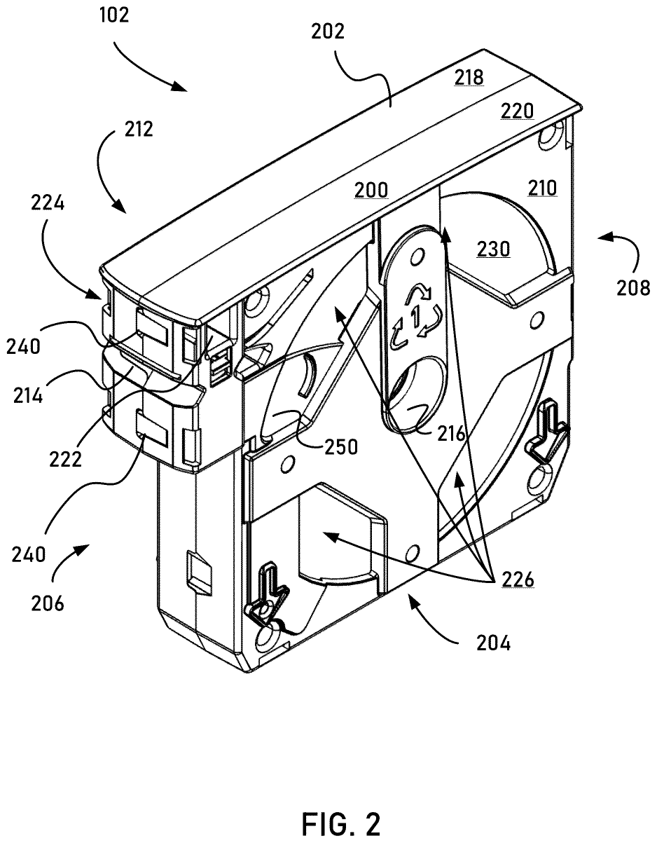

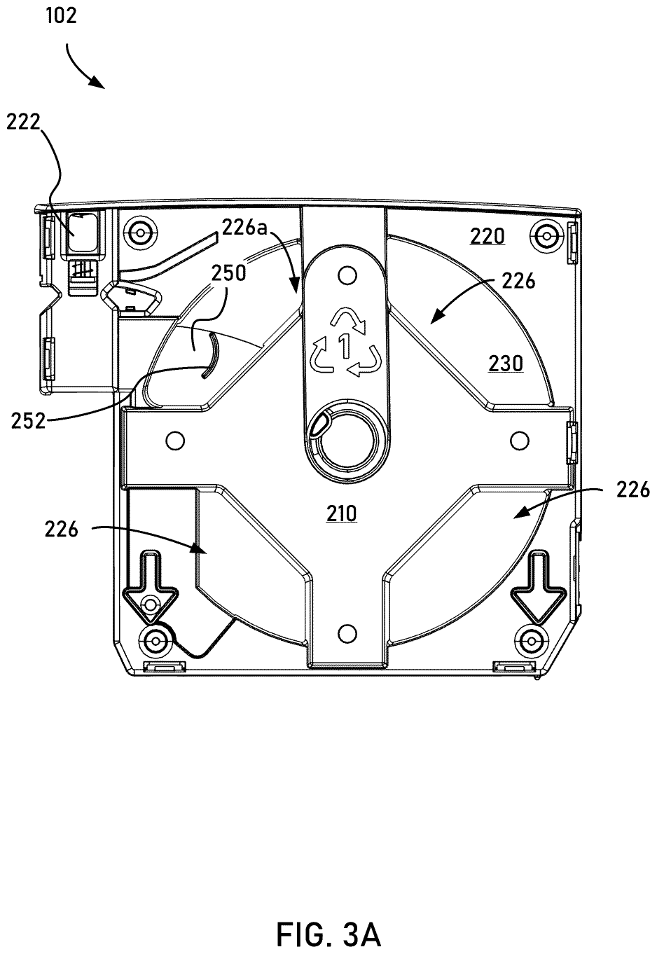

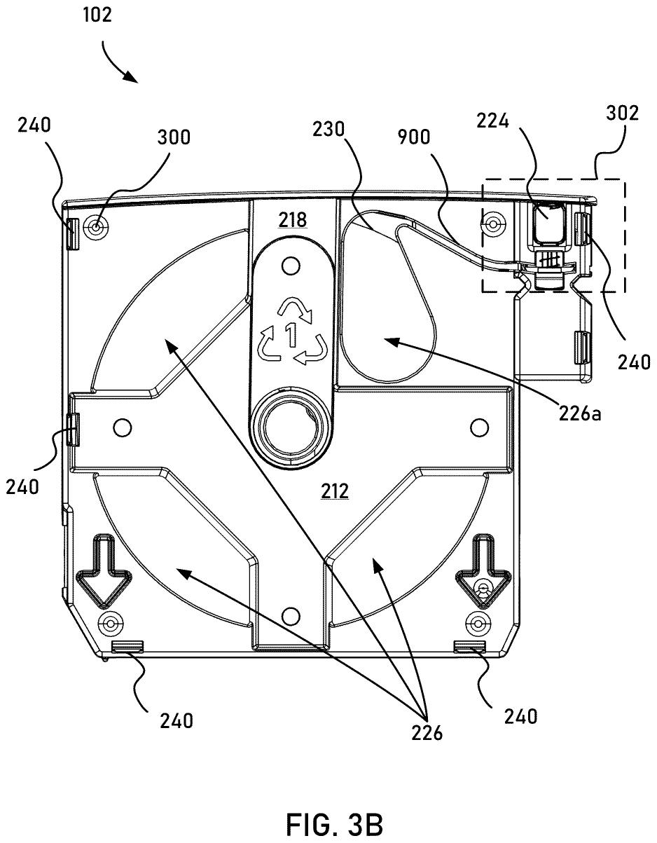

FIGS. 2 and 3A-B depict a cartridge 102 configured to be inserted into the media processing device 100 of FIG. 1. FIG. 2 is a perspective view of the cartridge 102 and FIGS. 3A-B are orthogonal profile views of the opposite sides of the media cartridge 102. The cartridge 102 includes a housing 200 that is configured to contain a roll of media 230. In the depicted embodiment, the roll of media 230 is a roll of wristbands attached end-to-end (e.g., forming a web of wristbands), the wristbands can be configured to receive indicia via a thermal printhead (e.g., a thermal printhead of the media processing device 100). Alternatively, the roll of media 230 may also include a web of labels (e.g., we of media., media web, etc.), a stack of fan-fold labels, or other configuration of media that allows for modular packing of the media within the cartridge 102. The housing 200 of the cartridge 102 has a first side 202 and a second side 204 disposed opposite the first side 202. The first side 202 is a “top” of the housing 200 (in the orientation shown in FIG. 2) and is configured to receive a force from a user when installing the cartridge 102 into the media processing device 100 and the second side 204 is a “bottom” of the housing 200 of the cartridge 102 (in the orientation shown in FIG. 2). The housing of the cartridge 102 further includes a third side 206, a fourth side 208, a fifth side 210, and a sixth side 212 (visible in FIG. 3B), where the third side 206 and the fourth side 208 are opposite from each other and the fifth side 210 and the sixth side 212 are opposite from each other.

The third side 206 (also referred to herein as the “output side”), features a media output 214 from which the media 230 is arranged to exit the housing 200 of the cartridge 102. When the cartridge 102 is inserted into the media processing device 100, the media output 214 is aligned with the media processing path of the media processing device 100. In the depicted embodiment, this allows the media 230 to exit the cartridge 102 at the media output 214, pass by the print head of the media processing device 100 and out the output 104 where the user can retrieve the processed media.

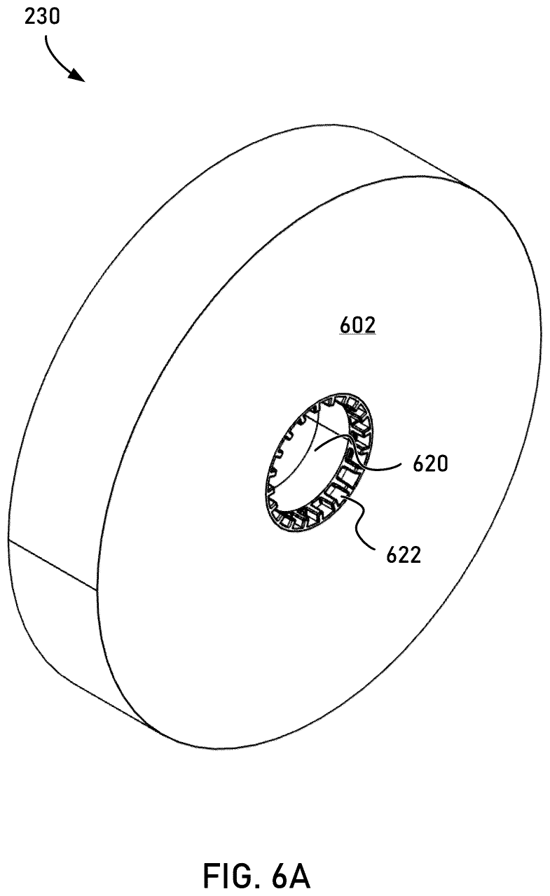

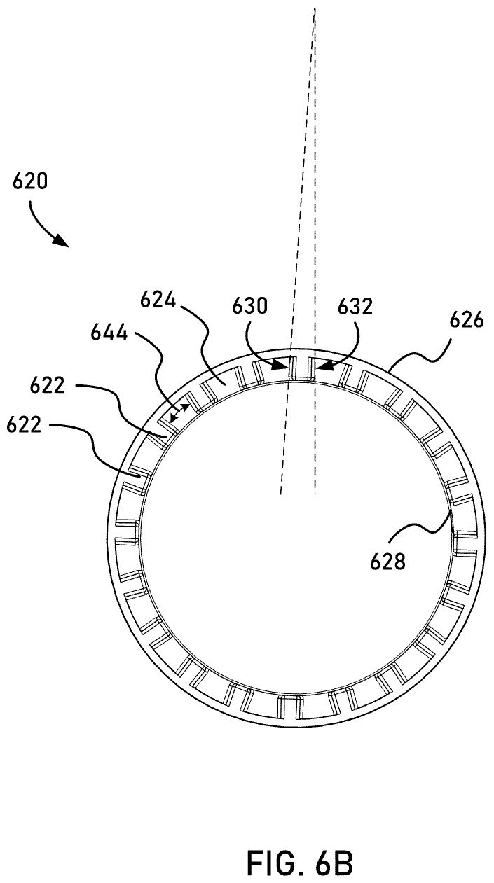

FIG. 2 further depicts a spindle 216 that extends axially from the fifth side 210 towards the sixth side 212. The spindle 216 is configured such that the roll of media 230, having an roll core (e.g., roll core 620 shown in FIGS. 6A-6B) in which the media is wrapped around, is rotatably supported by the spindle 216. The spindle 216 is assembled via the combination of a first component 218 of the housing 200 and a second component 220 of the housing 200. As will be discussed further below, the housing 200 of the cartridge 102 is assembled by joining the first component 218 and the second component 220. Each of the first component 218 and the second component 220 can form a portion of the first through sixth sides of the housing 200. Alternatively, the second component 220 can form the first through fifth sides of the housing 200 and the first component 218 can form the sixth side of the housing 200 or the first component 218 can form the first through fourth and sixth sides of the housing 200 and the second component 220 can form the fifth side of the housing 200. When the first component 218 and the second component 220 are joined together, the spindle 216 is concentrically aligned within a roll of media 230 (e.g., in the cylindrical core) which allows the media 230 to be rotatably supported within the housing 200 of the cartridge 102.

In the depicted embodiment, with reference to FIGS. 2 and 3A-B, the fifth side 210 further includes a first aperture 222 and the sixth side further includes a second aperture 224 (e.g., as further shown in FIG. 3B). The first aperture 222 and the second aperture 224 are discussed in further detail below as they relate to accessing and removing internal components via the first aperture 222 and/or second aperture 224. The first aperture 222 is depicted as positioned opposite a second aperture 224. The first aperture 222 and second aperture 224 are disposed proximate to the cartridge output 214, above a media path of the media 230 within the housing 200 (relative to the orientation of the housing illustrated in FIG. 2) and aligned with at least a portion of a media stop assembly within the housing 200.

FIGS. 2 and 3A-B further depict openings 226 in the wall of the fifth side 210 and the sixth side 212. In some embodiments, the cartridge 102 may only have openings 226 in one side of the housing 200 of the cartridge 102. The openings 226 allow the roll of media 230 to be seen without requiring opening the cartridge 102. This aids the user in quickly and easily knowing how much media is left within the cartridge 102. As will be discussed further below, the openings 226 also allows the media web of the media roll to be accessed should the media web need to be rethreaded out of the cartridge output 214 or retracted into the cartridge.

As depicted in FIG. 3A, a portion of an arm 250 is viewable through a first opening 226a. The arm 250 forms a portion of the roll stop assembly, which is discussed and depicted in greater detail in the subsequent figures. The arm 250 may also include a protrusion 252, which may be accessible (e.g., to a user) and manipulated via the first opening 226a. The protrusion 252 is also discussed in greater detail in subsequent sections.

As depicted in FIG. 3B, the first component 218 and the second component 220 of the cartridge 102 may be guided together via alignment elements 300.

When assembling the housing, tabs 240 are secured around the perimeter of the first component 218 and the second component 220. Other embodiments for securing the housing 200 may include assembled or joined secured with tabs along the perimeter, or by using fasteners, snaps, adhesives, solvent bonding, ultrasonic welding, or using adhesive backed tape or a label. The first and second components 218 and 220 of the cartridge 102 typically need to be secured together so that the cartridge 102 does not come apart due to minimum forces being applied. The roll of media 230 is positioned within the housing 200 of the cartridge 102 such that if the housing of the cartridge 102 is opened, the roll of media 230 can be damaged, become unaligned, or unusable.

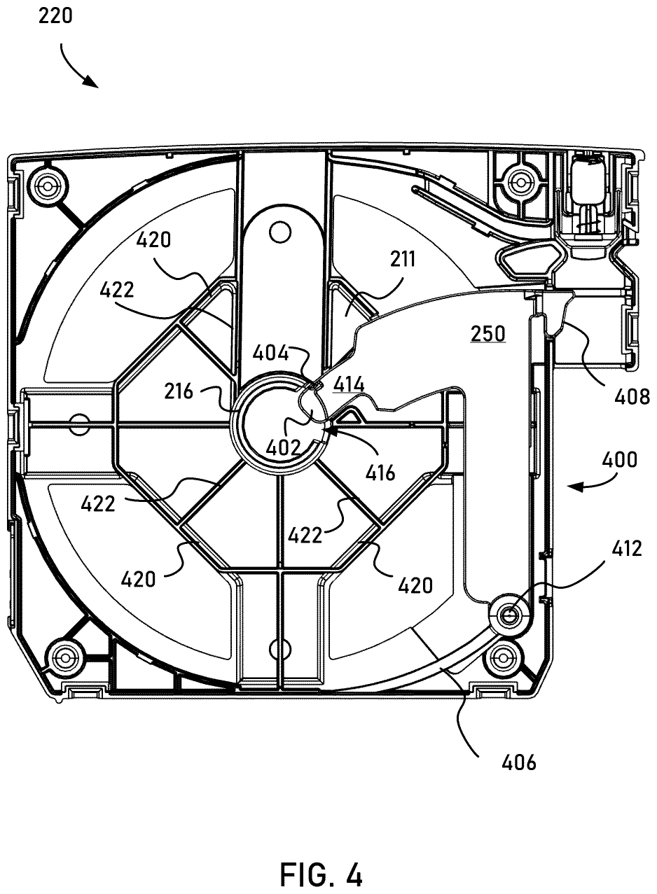

FIG. 4 illustrates an interior profile view of the second component 220 of the housing 200 (without the first component 218 and the roll of media 230), including certain internal features of the cartridge 102, according to embodiments of the present disclosure. Viewable in FIG. 4 is a roll stop assembly 400, including the arm 250. The spindle 216 includes a slot 416 through which an elongate portion 414 of the arm 250 protrudes, and includes a hollow cylindrical profile, into which the elongate portion 414 extends. The elongate portion 414 of the arm 250 includes an embossment 402 including an external tooth 404, which protrudes from the embossment 402 in a generally radial direction. The elongate portion 414 of the arm 250 is generally configured such that the embossment 402 is generally located within the cylindrical profile of the spindle 216 and the external tooth 404 can be selective moved into and out of the cylindrical profile. In some examples, the embossment 402 includes a plurality of external teeth 404.

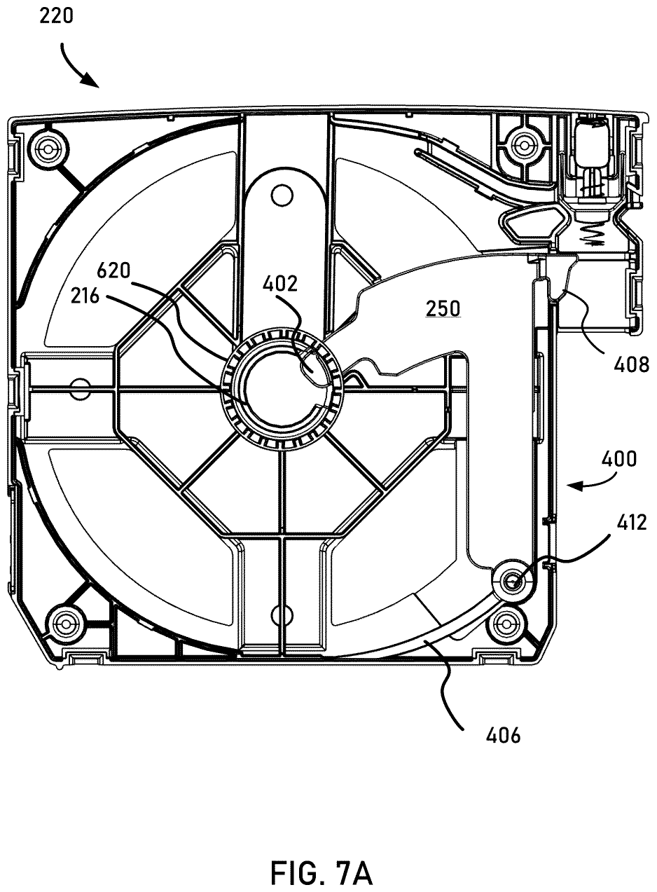

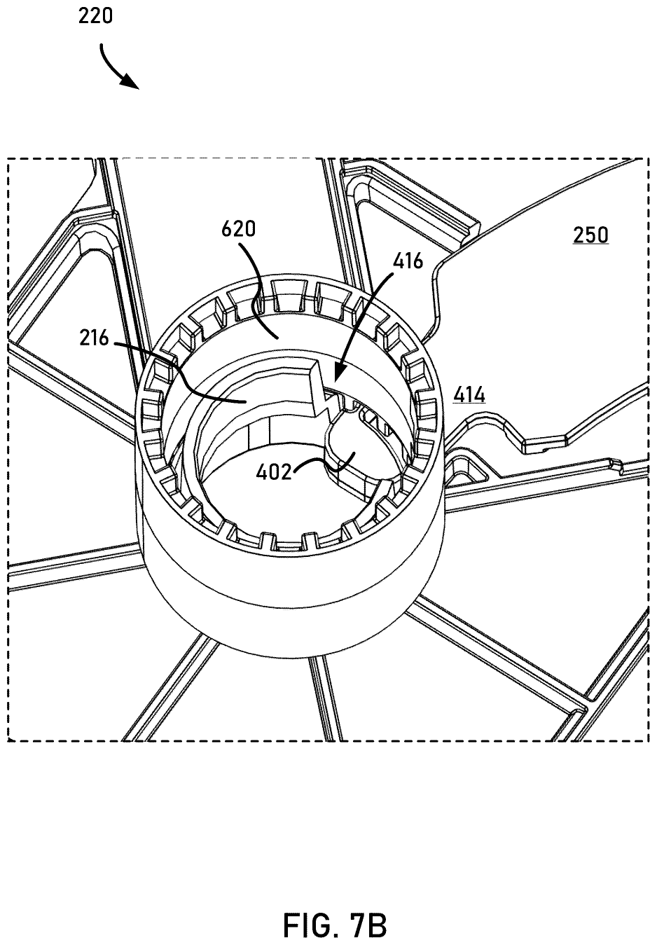

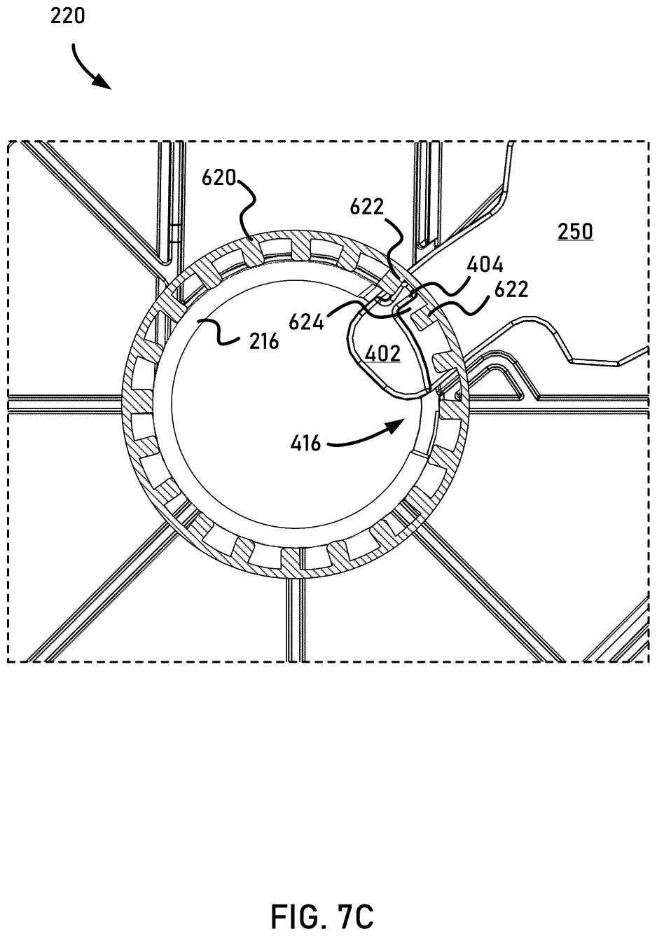

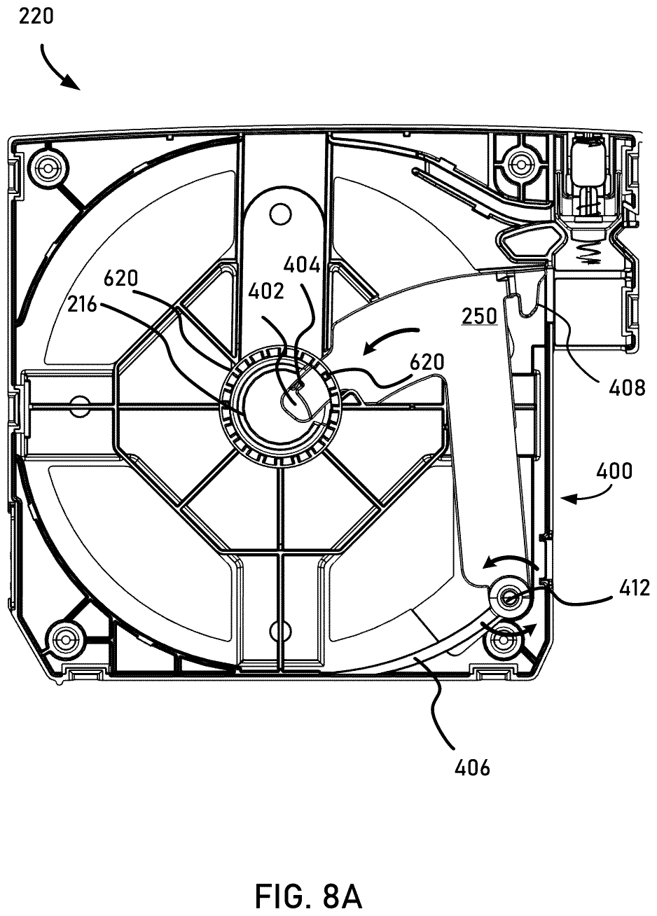

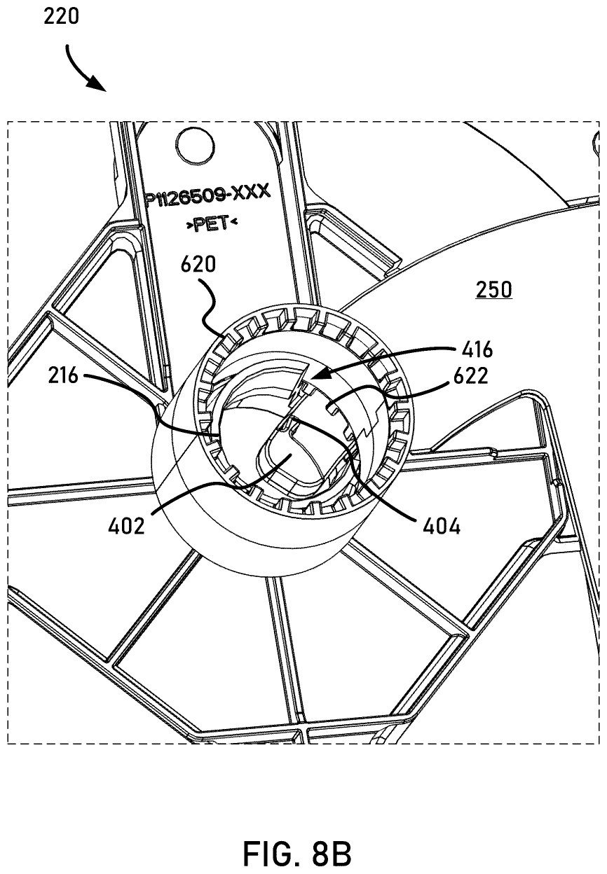

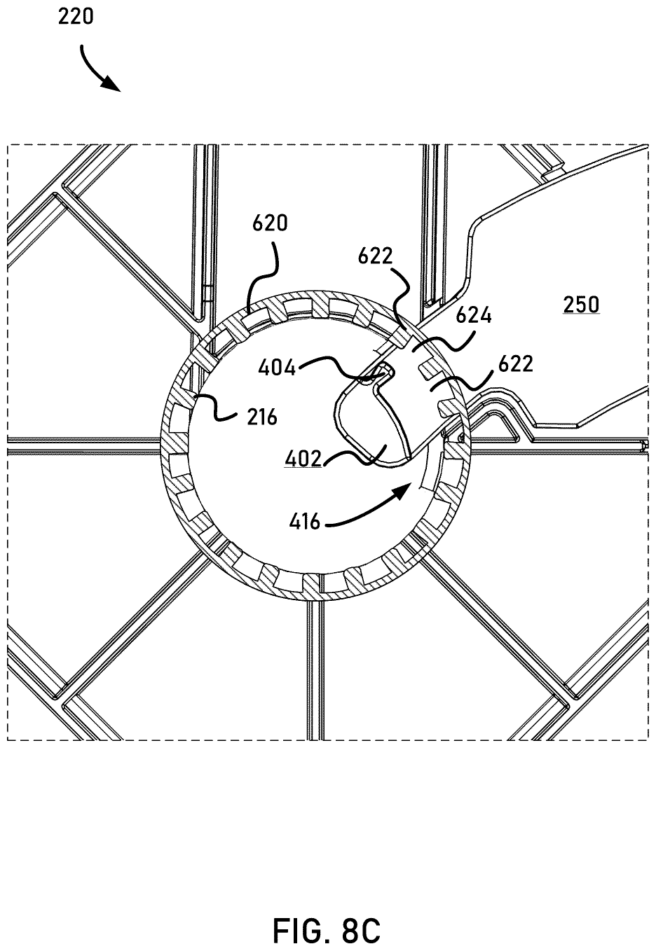

The arm 250 is hingedly attached to the second component 220 (e.g., generally the housing 200) at a hinge 412. The arm 250 is rigidly coupled with a biasing element 406, which biases the arm 250 against an inner surface of the second component 220 (e.g., generally the side 204 of the housing 200) such that a biasing torque (e.g., clockwise torque as depicted in FIG. 4) is applied to the arm 250 positioning the roll stop assembly 400 in a roll hold position. When the biasing torque is overcome by an opposing applied torque, the arm 250 is configured to rotate about the hinge 412 (e.g., in a counterclockwise direction in the orientation shown in FIG. 4) such that the elongate portion 414 extends further into the slot 416 of the spindle 216 and the external tooth 404 extends into the cylindrical profile to position the roll stop assembly 400 in a roll release position. When the applied torque is no longer applied, the biasing torque of the biasing element 406 causes the arm 250 to again rotate in the clockwise direction in the orientation shown in FIG. 4 retract from the slot 416 of the spindle 216 causing the extern tooth 404 to protrude from the spindle 216 via the sloth 416 and return to the roll hold position illustrated in FIG. 4. The above-described action is the basis of the media hold-and-release features of the cartridge 102, which is described in greater detail with respect to FIGS. 7A-8C.

The arm 250 is generally configured so as to be substantially planar, or “flat” with the exception of the embossment 402 and the external tooth 404, as the arm 250 is disposed between the roll of media 230 and an inner surface 211 of the fifth side 210 of the housing 200.

According to some embodiments, and as depicted, the biasing element 406 is a leaf spring, however other embodiments of the biasing element 406 are contemplated, such as tension springs, coil springs, torsion springs, other conventional biasing elements, and the like.

Although illustrated as secured to the second component 220, this disclosure contemplates embodiments where various components of the roll stop assembly 400 are secured to the first component 218 of the housing 200, a combination of the first component 218 and the second component 220, or other parts of the housing 200.

The roll stop assembly 400 also includes a tab 408, which protrudes through an opening in the wall of the housing 200 on the third side 206 of the cartridge 102. The tab 408 is rigidly coupled to the arm 250 and is translatable therewith. In some examples, the tab 408 may be a point of reception for an external force which can oppose and overcome the biasing torque of the biasing element 406 (e.g., from the media processing device 100) to move the roll stop assembly 400 from the roll hold position to the roll release position).

FIG. 4B illustrates a detailed view of the second portion 220 of the housing 200, according to embodiments of the present disclosure. The housing 200 includes several structural ribs 420 integrated with the first component 218 and the second component 220 which are configured to provide structural stability to the cartridge 102. In order to facilitate relatively unobstructed rotation of the media roll about the spindle (e.g., when the roll stop assembly is in the roll-release position) at least some of the ribs 420 which are disposed proximately to the spindle 216, may include relief cuts 422 which decrease a “height” of the ribs 420, which is determined as a distance from the inner surface 211 of the fifth side 210 of the housing 200 for ribs extending from the fifth side 210 or a distance from the inner surface of the sixth side 212 of the housing 200 for ribs extending from the sixth side 212. Said differently, a portion of the structural ribs of the housing 200 proximate to the roll core (e.g., roll core 620 shown in FIG. 6) of roll of media 230 are configured to protrude from a respective surface to a lesser extent than a portion of the structural ribs less proximate to the roll core of the roll of media 230.

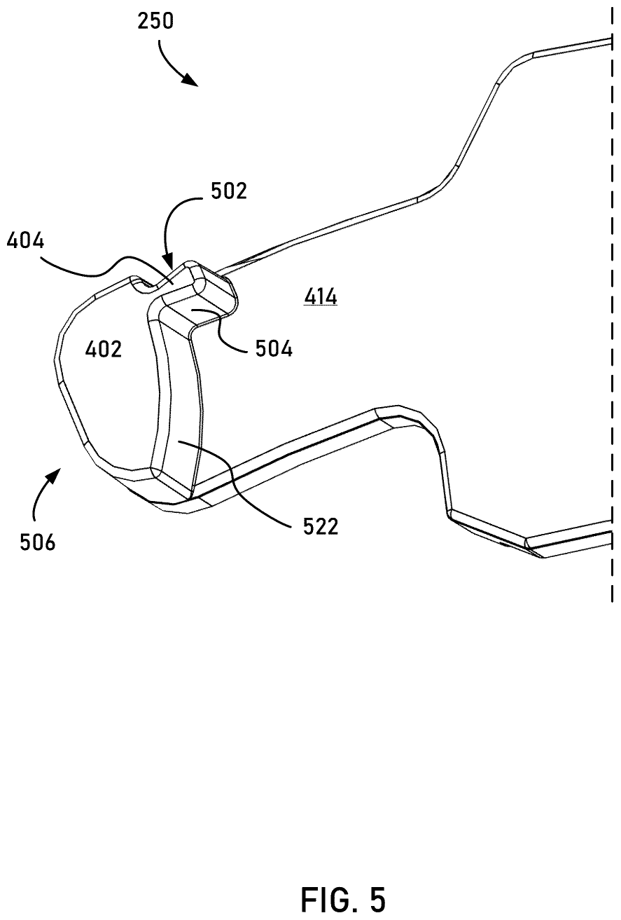

FIG. 5 illustrates a detailed perspective view of the elongate portion 414 of the arm 250, according to embodiments of the present disclosure. Referring to FIGS. 4 and 5, the embossment 402 is generally located at a distal, terminal end 506 of the elongate portion 414, such that the embossment 402 is the distalmost feature of the elongate portion 414 which protrudes into the slot 416 of the spindle 216. The external tooth 404 of the embossment protrudes from a surface 522 of the embossment 402 and also from the surface 522 of the elongate portion 414 from which the embossment 402 protrudes. The external tooth 404 is oriented such that the tooth protrudes from the surface 522 of the embossment 402 in a direction generally away from the distal end 506 of the elongate portion 414. In some examples, the surface 522 can have a curvature that corresponds to the radius of curvature of the spindle 416 and can be flush with a surface of the spindle 416 when the roll stop assembly 400 is positioned in the roll hold position. In some examples, the surface 522 is matched with the internal surface 628 (See FIG. 6B) of the roll core 620 (see FIG. 6A-6B), such that when aligned, contact is substantially maintained between the surface 522 of the embossment and the internal surface 628 of the roll core 620.

The external tooth 404 includes a first surface 502 and a second surface 504. According to some embodiments, the planes in which the first surface 502 and the second surface 504 are defined are oblique with one another, such that a width of the external tooth 404 is increases away from the distal end 506 of the elongate portion 414.

FIG. 6A illustrates a roll of media 230, as may be contained in and dispensed by the cartridge 102. The roll of media 230 includes a roll core 620 which defines a plurality of internal teeth 622 (generally internal teeth 622, individually internal tooth 622) about an internal circumference of the roll core 620. The roll of media 230 further includes a media web 602 wound about the roll core 620 forming the roll.

FIG. 6B illustrates a profile view of the roll core 620. The internal teeth 622 are defined about the internal surface 628 of the roll core 620. The internal teeth 622 substantially form an internal gear pattern, defined by gaps 624 between each pair of internal teeth 622. Each gap 624 has a gap width 644, which is configured such that the external tooth 404 of the arm 250 has sufficient clearance to slot into a gap 624. In some examples, the gaps 624 are configured to be wider than the external tooth 404 by at least a factor of 1.5, and at most a factor of 5.

Each internal tooth 622 includes a first tooth face 630 opposed to a second tooth face 632, and the planes in which the first tooth face 630 and the second tooth face 632 are defined are oblique with one another, and the planes intersect beyond an external surface 626 of the roll core 620. Stated differently, the first plane and the second plane intersect at a point that is located at a greater distance from a radial center of the roll core 620 than a length of a radius to the internal surface 628 of the roll core.

FIGS. 7A-7C illustrate several views of the roll stop assembly 400 and the roll core 620 in the roll-hold position, according to embodiments of the present disclosure. The roll stop assembly 400 has a roll-hold position (FIGS. 7A-7C) and a roll release position (FIGS. 8A-8C). FIG. 7A illustrates a profile view of the second component 220, the roll stop assembly 400 and the roll core 620, according to embodiments of the present disclosure. FIG. 7B illustrates a detailed perspective view of the embossment 402, the spindle 216, the roll core 620, and other associated components. FIG. 7C illustrates a detailed and sectioned view of the same features of FIG. 7B, such that the engagement between the external tooth 404 and the internal teeth 622 of the roll core 620 is easily viewable.

Generally speaking, the roll stop assembly 400 is translatable between the roll-hold position and the roll-release position. In the roll hold position, the roll stop assembly 400 is configured to block rotation of the roll of media 230 (e.g., via the roll core 620) about the spindle 216. In the roll release position, the roll of media 230 is rotatable about the spindle 216, as may be conducive to the dispensation of the media web 602 from the cartridge 102.

When in the roll hold position, the external tooth 404 of the elongate portion 414 engages one or more of the internal teeth 622 of the roll core 620. In terms of engagement between the external tooth 404 and the one or more of the internal teeth 622, the external tooth 404 slots into a gap 624 between a pair of the internal teeth 622. In some examples, the mating angle between the surfaces of the external tooth 404 and the internal teeth 622 (e.g., the first surface 502 and the second surface 504 abutting on of the first tooth face 630 and the second tooth face 632) is oblique with respect to a radial direction of the roll core 620. The oblique mating angle is configured such that when the external tooth 404 is engaged with the internal teeth 622 and a force or torque is applied to the roll of media 230 in a manner that would be sufficient to rotate the roll of media 230 about the spindle 216 if not for the roll stop assembly being in the roll hold position, that the applied force forces the external tooth 404 further into the gap 624, substantially preventing rotation of the roll and disengagement of the external tooth 404.

In embodiments where the embossment 402 includes a plurality of external teeth 404, the external teeth 404 may be configured to simultaneously engage with a plurality of internal teeth 622 when the roll stop assembly 400 is in the roll-hold position.

Generally, the biasing element 406 (FIG. 4) biases the arm 250 such that the roll stop assembly 400 is in the roll hold position. As discussed previously, the biasing element 406 is rigidly coupled to the arm 250, which is otherwise free to rotate (e.g., through a predetermined range) about the hinge 412. The biasing element 406 may be installed such that the biasing element 406 is in a state of tension and is thus applying a substantially consistent torque to the arm 250. The biasing element 406 may bias the arm 250 against various portions of the housing 200, and as illustrated, the biasing element 406 biases the arm 250 against the second side 204 or “bottom” of the housing. 200.

FIGS. 8A-8C illustrate the roll stop assembly in the roll-release position, according to embodiments of the present disclosure. FIG. 8A illustrates a profile view of the second component 220, the roll stop assembly 400 and the roll core 620, according to embodiments of the present disclosure. FIG. 8B illustrates a detailed perspective view of the embossment 402, the spindle 216, the roll core 620, and other associated components. FIG. 8C illustrates a detailed and sectioned view of the same features of FIG. 7B, such that the disengagement between the external tooth 404 and the internal teeth 622 of the roll core 620 is easily viewable. When in the roll-release position, the arm is 250 is rotated against the biasing torque of the biasing element 406 (FIG. 4). The rotation of the arm 250 causes the elongate portion 414 of the arm 250 to translate towards the radial center of the spindle 216, such that elongate portion 414 moves “further into” the slot 416. Thus, the embossment 402 and the external tooth 404 are retracted from the internal teeth 622 and the external tooth 404 disengages from the internal teeth 622, such that the roll stop assembly 400 does not block the roll of media 230 or the roll core 620 from rotating about the spindle 216. Stated differently, the external tooth 404 is moved away from the plurality of internal teeth 622, such that the roll of media 230 is rotatable about the spindle 216.

The roll stop assembly 400 may be transitioned from the roll-hold position to the roll-release position by the media processing device 100, or by a user. When the cartridge 102 is inserted into place in the media processing device 100, the tab 408 is aligned with a printer feature which is configured to apply a force to the tab 408, such that the arm 250 is rotated against the bias of the biasing element 406. The printer feature may be fixed such that when the cartridge 102 is installed in the printer, the roll stop assembly is secured in the roll-release position.

The arm 250 includes a protrusion 252, e.g., depicted in FIG. 3A. The protrusion 252 is configured to be accessible through the first opening 226a, such that a user may apply a force to the protrusion 252 which results in a torque on the arm 250 which is sufficient to overcome the biasing torque of the biasing element 406 such that the roll stop assembly 400 is transitioned from the roll hold position to the roll release position.

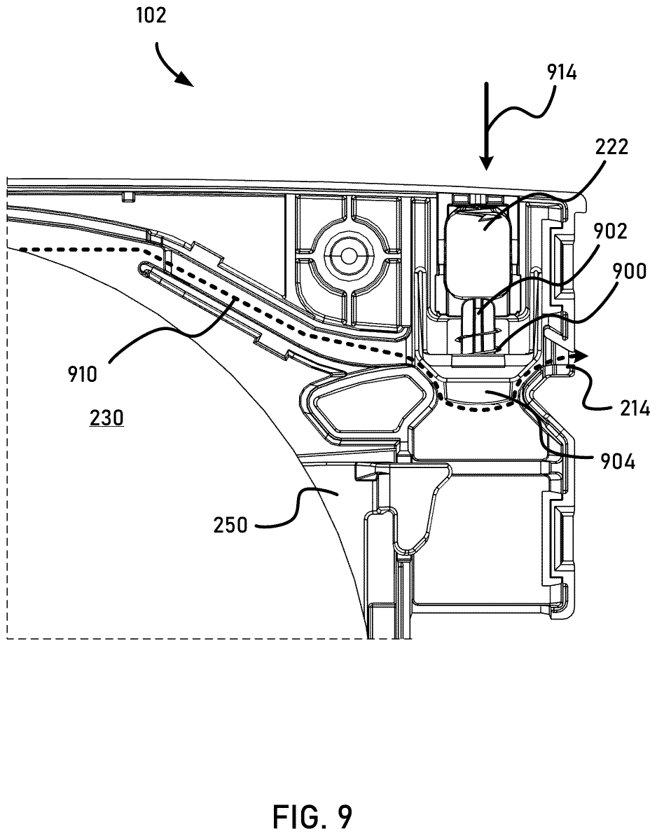

FIG. 9 depicts an enhanced view of a region 302 noted in FIG. 3B showing the second aperture 224 and components thereof in more detail.

Within the second aperture 224, a biasing member (also referred to herein as spring 900) can be observed within the housing 200. The spring 900 is fully visible and accessible through the first aperture 222 and the second aperture 224. As depicted in FIG. 9, the spring 900 is mounted on a post 902, which is part of a media stop assembly 904 described herein. The spring 900 is configured to bias the media stop assembly 904 in a direction 914, which in FIG. 9 is a downward direction per the orientation depicted. In the depicted embodiment, the media stop assembly 904 is biased downward to apply a pressure against a media web extending from the roll of media 230 (e.g., shown in FIGS. 2 and 3A-B) along a media path 910 to the cartridge output 214. The media stop assembly 904 holds the media web in place and prevents the roll of media 230 from unspooling, e.g., when the cartridge 102 is not installed in a media processing device 100.

Said differently, the media stop assembly 904 is configured to transition between a media release position and a media hold position, such that when the media stop assembly is in the media hold position, media web of media is pinched between the media stop assembly 904 and a surface and when the media stop assembly 904 is in the media release position, the media stop assembly is separated from the surface and does not block movement of the web of media.

In some examples, the printer feature which is configured to transition the roll stop assembly 400 to the roll-release position when the cartridge 102 is inserted into the media processing device 100 is further configured to translate the media stop assembly 904 from the media hold position to the media release position at the same instance. Thus, the roll stop assembly 400 is configured to be translated from the roll hold position to the roll release position and the media stop assembly 904 is configured to be translated form the media hold position to the media release position responsive to a single action, the single action being insertion of the media cartridge 102 into the media processing device 100.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A media cartridge comprising:
a housing, comprising:
a spindle configured to rotatively support a media roll, the spindle having a hollow cylindrical profile and a slot;
a media roll comprising:
a roll core, the roll core configured to rotate about the spindle, the roll core comprising a plurality of internal teeth disposed about an internal circumference of the roll core; and
a web of media, wound about the roll core; and
a roll stop assembly configured to transition between a roll hold position and a roll release position, comprising:
an arm, rotatively coupled to the housing,
wherein a portion of the arm is configured to extend through the slot of the spindle and into the hollow cylindrical profile, the portion of the arm comprising an embossment comprising at least an external tooth;
a biasing member, configured to bias the arm into the roll hold position,
wherein, when in the roll hold position, the external tooth of the embossment of the arm engages with at least one of the plurality of internal teeth of the roll core, blocking the media roll from rotating about the spindle; and
wherein the roll stop assembly is configured to transition from the roll hold position to the roll release position by rotating the arm such that the external tooth disengages from the at least one of the plurality of internal teeth;
wherein, when in the roll release position, the external tooth is retracted away from the plurality of internal teeth, such that the media roll is rotatable about the spindle.

2. The media cartridge of claim 1, wherein a mating angle between the at least one of the plurality of internal teeth and the external tooth is configured such that when a rotative force is applied to the media roll when the roll stop assembly is in the roll hold position, the external tooth is biased towards the roll core.

3. The media cartridge of claim 2, each internal tooth of the plurality of internal teeth includes a first tooth face opposed to a second tooth face, the first tooth face defined in a first plane and the second tooth face defined in a second plane, such that the first plane and the second plane intersect at a point that is located at a greater distance from a radial center of the roll core than an internal circumference of the roll core.

4. The media cartridge of claim 1, wherein the plurality of internal teeth are configured such that a gap width of a gap between each pair of teeth of the plurality of internal teeth is at least 1.5 times a tooth width of the external tooth.

5. The media cartridge of claim 1, wherein the embossment includes a plurality of external teeth, each external tooth of the plurality of external teeth configured to simultaneously engage with the plurality of internal teeth of the roll core when the roll stop assembly is in the roll hold position.

6. The media cartridge of claim 1, wherein the biasing member is a leaf spring.

7. The media cartridge of claim 1, wherein the biasing member is integrally formed with the arm.

8. The media cartridge of claim 1, wherein the roll stop assembly includes a tab which extends through an opening in the housing and is coupled to the arm, configured to receive an external force which transitions the roll stop assembly from the roll hold position to the roll release position.

9. The media cartridge of claim 8, wherein the tab is a first tab configured to receive the external force from a printer.

10. The media cartridge of claim 1, further comprising a protrusion on the arm configured to receive an external force from a user applying a force, such that the roll stop assembly is transitioned from the roll hold position to the roll release position.

11. The media cartridge of claim 1, further comprising a media stop assembly configured to translate between a media release position and a media hold position, such that when the media stop assembly is in the media hold position, media web of media is pinched between the media stop assembly and a surface and when the media stop assembly is in the media release position, the media stop assembly is separated from the surface and permits movement of the web of media.

12. The media cartridge of claim 11, wherein the roll stop assembly is configured to be translated from the roll hold position to the roll release position and the media stop assembly is configured to be translated from the media hold position to the media release position responsive to a single action.

13. The media cartridge of claim 1, wherein the housing comprises structural ribs, the structural ribs comprising reliefs disposed proximately to the spindle.

14. The media cartridge of claim 1, wherein the housing is formed by a first housing side and a second housing side, and the spindle is formed by a first spindle portion, integrally formed with the first housing side and a second spindle portion integrally formed with the second housing side, the slot formed in one of the first spindle portion or the second spindle portion.

15. The media cartridge of claim 1, wherein the embossment includes a curved surface matched with an internal surface of the hollow cylindrical profile of the spindle.

16. A media cartridge comprising:
a housing, comprising:
a spindle configured to rotatively support a media roll, the spindle having a hollow cylindrical profile and a slot;
a roll stop assembly configured to transition between a roll hold position and a roll release position, comprising:
an arm, rotatively coupled to the housing;
wherein a portion of the arm is configured to extend through the slot of the spindle and into the hollow cylindrical profile, the portion of the arm comprising an embossment comprising at least an external tooth;
a biasing member, configured to bias the arm into the roll hold position;
wherein, when in the roll hold position, the external tooth of the embossment of the arm protrudes from the spindle through the slot; and
wherein the roll stop assembly is transitioned from the roll hold position to the roll release position by rotating the arm such that the external tooth is translated towards a radial center of the hollow cylindrical profile and out of the slot;
wherein, when in the roll release position, the external tooth retracts into the spindle away from the slot.

17. The media cartridge of claim 16, further comprising:
a media roll comprising:
a roll core, the roll core configured to rotate about the spindle, comprising a plurality of internal teeth disposed about an internal circumference of the roll core; and
a web of media, wound about the roll core;
wherein when in the roll hold position, the external tooth of the embossment of the arm engages with the plurality of internal teeth of the roll core, blocking the media roll from rotating about the spindle;
wherein, when in the roll release position, the external tooth is disengaged from the plurality of internal teeth and permits rotation of the media roll.

18. A media roll, comprising:
a roll core, comprising a plurality of internal teeth disposed about an internal circumference of the roll core,
wherein each internal tooth of the plurality of internal teeth includes a first tooth face opposed to a second tooth face, the first tooth face defined in a first plane and the second tooth face defined in a second plane, such that the first plane and the second plane intersect at a point that is located at a distance from a radial center of the roll core greater than a radius of the internal circumference of the roll core; and
a web of media, wound about the roll core.

19. The media roll of claim 18, wherein the web of media is comprised of media elements selected from a group consisting of labels, wristbands, RFID tags, printable media, and combinations thereof.
